(19) United States
(12) Patent Application Publication
(10) Pub. No.: US 2006/0020518 A1
(43) Pub. Date: Jan. 26, 2006

(54) Systems and methods for accessing real estate information

(76) Inventors: Douglas I. Lovison, Cardiff, CA (US); Tyrone Gaines Montgomery, Vista, CA (US); George Kosty III, Carlsbad, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 10/897,707

(22) Filed: Jul. 22, 2004

(51) Int. Cl. G06Q 30/00

(52) U.S. Cl. 705/26

(57) ABSTRACT

The present invention provides systems and methods for allowing access and retrieval of selected real estate information by a plurality of users, wherein one or more wired or wireless devices are provided in communication with a server database containing real estate information. A software application resides on the server and each device to permit communication between the server and the devices such that the devices are capable of bi-directional communication with the server.

### FIELD OF THE INVENTION

This invention relates generally to systems and methods for identifying and retrieving real estate information.

### BACKGROUND OF THE INVENTION

The current real estate industry trend is toward a more global real estate market featuring large regional and national providers. This has led to a mass consolidation among the smaller local and regional brokers in which local brokers are being replaced by national real estate companies. On a national or international scale, the real estate industry is so large and fragmented that there exists very limited research data. In view of the industry trend toward larger brokers, there exists a need for more accurate national real estate data. Parties in the real estate industry that require extensive information include sales/leasing brokers, property owners/managers, construction firms, real estate developers, banks, investors, asset managers, government agencies, security issuers, appraisers and insurers.

An efficient contemporary real estate requires accurate and comprehensive research capabilities as well as real-time access to relevant information. The Internet is a mass communications and commerce medium enabling millions of people worldwide to share information and conduct business electronically. The Internet and related technologies permit easy access to increasingly greater volumes of real-time information at low cost without geographic limitation. By taking advantage of the Internet's capabilities, smaller real estate broker can level the playing field by accessing the same information as larger brokers.

In view of the above, there exists a need for systems and methods for identifying and retrieving real-time real estate information that facilitates the buying and selling of real estate.

### SUMMARY OF THE INVENTION

The present invention provides systems and methods for allowing access and retrieval of selected real estate information by a plurality of users, wherein one or more wired or wireless devices are provided in communication with a server database containing real estate information. A software application resides on the server and each device to permit communication between the server and the devices such that the devices are capable of bi-directional communication with the server.

According to an aspect of the invention, users employing wired devices may access server over the Internet via an ISP. Suitable wired devices include, but are not limited to, personal computers. On the other hand, users employing wireless devices may communicate with the server via a wireless communications network that enables communication with the Internet, which is provided in communication with server. Suitable wireless devices include, but are not limited to GPS equipped wireless devices, PDAs, cellular phones and wireless enabled laptops. Preferably, the GPS equipped wireless devices are used to access a multiple listing service via GPS technology to pinpoint the precise location of a given property. GPS technology may also be used to locate listed real estate open houses and display the date, time and duration of the open house.

In accordance with another aspect of the present invention, the selected real estate information is chosen from the group consisting of buyer/renter applications, seller/lessor applications and advertiser applications. Additionally, photographs, streaming video, and aerial photographs of the a selected property may be accessed using a wired or wireless device of the present invention. Further, the devices may be used to access demographic information such as the quality of local schools, the quality of local neighborhoods, the proximity and location of hospitals, the proximity and location of shopping, and the proximity and location of entertainment. According to some embodiments, the devices may be used to access and retrieve global real estate listings and related information, which are sorted by predetermined search parameters such as location, price, type of property, square footage and number of bedrooms. According to other embodiments, the devices may be used to make a virtual tour of a selected real estate listing. According to further embodiments, the devices may be used to upload real estate information, photos, streaming video and other data in real-time.

A further aspect of the present invention involves a method of identifying and retrieving real estate information by a user, wherein the method comprises the steps of using a wired or wireless device to access an appropriate website on the Internet, selecting a specific region of the world within which to begin a search, determining the search parameters from a variety of criteria, querying the server database to identify preferred real estate listings that meet the criteria parameters and viewing the preferred real estate listings. According to some embodiments, the method also includes the steps of selecting a specific real estate listing to view a more detailed screen for the selected listing and viewing the detailed screen of the selected real estate listing. According to other embodiments, the method also includes the steps of connecting to a listing agent's or lessor's website by clicking on an appropriate link, directly contacting a listing agent or lessor by clicking an appropriate link, and/or connecting to an advertiser's website or directly contacting an advertiser by clicking on an appropriate link.

### BRIEF DESCRIPTION OF THE DRAWINGS

These and other features and advantages of the invention will become more apparent upon reading the following detailed description and upon reference to the accompanying drawings.

FIG. 1 is a block diagram of a system for allowing access and retrieval of selected real estate information in accordance with the principles of the present invention;

FIG. 2 is a flowchart of a method of identifying and retrieving real estate information by a user in accordance with the principles of the present invention;

FIG. 3 is a block diagram of a method of establishing and using a seller's database account for identifying and retrieving real estate information in accordance with the principles of the present invention; and

FIG. 4 is a block diagram of a method of establishing and using an advertiser's database account for identifying and retrieving real estate information in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

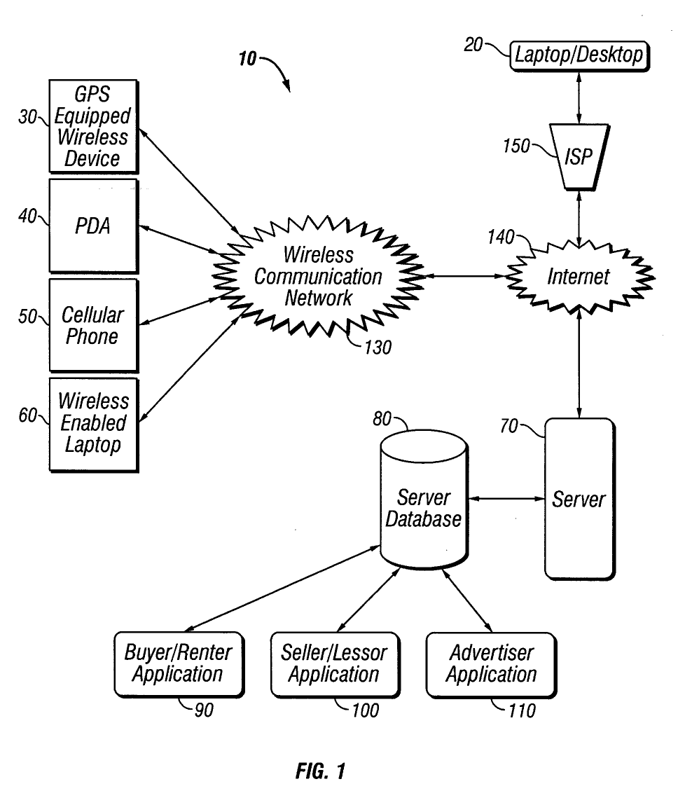

In accordance with the principles of the present invention, a system 10 for identifying and retrieving real estate information will now be described. Referring to FIG. 1, system 10 comprises one or more devices 20, 30, 40, 50, 60 provided in communication with one or more servers 70. Devices 20, 30, 40, 50, 60 comprise any devices capable of bi-directional communication with the server with or without the use of physical connection, and with utilizing one or more digital processors, and some form of data storage. The field such devices is constantly evolving, and future wired and wireless devices developed in this field are intended to be covered by the scope the present invention. Currently known devices that are suitable for use include, but are in no way limited to, cellular phones, wired phones, wireless phones, mobile phones, smart phones, WAP phones, personal computers, laptops, tablet computers, personal digital assistants (PDAs) and handheld gaming devices.

In the illustrated embodiment, devices 20, 30, 40, 50, 60 comprise wired equipment such as personal computer 20 as well as wireless equipment such as Global Positioning Satellite (GPS) equipped wireless device 30, personal digital assistant (PDA) 40, cellular phone 50 and wireless enabled laptop 60. As would be appreciated by one of ordinary skill in the communications art, any number of additional devices and/or additional servers may be provided without departing from the scope of the present invention.

System 10 provides access and retrieval of real estate information by server 70 is provided in communication with a server database 80, which stores pertinent information, such as including buyer/renter applications 90, seller/lessor applications 100 and advertiser applications 110. Wireless users employing wireless devices 30, 40, 50, 60 can communicate with server 70 via a wireless communications network 130 that enables communication with the Internet 140, which is provided in communication with server 70. Wireless communications network 130 represents any conventional communications hardware and supporting software that provides links between devices 30, 40, 50, 60 and server 70. Depending on the local and remote system topology, wireless communications network 130 may include various types and numbers of auxiliary networks, phone lines, high speed fiber optic backbones, routers, gateways and other conventional communication equipment that handles network traffic.

With further reference to FIG. 1, users employing wired devices such as personal computer 20 may access server 70 over the Internet via an Internet Service Provider (ISP) 150. A web-based or wireless software application protocol preferably resides on server 70 as well as each device 20, 30, 40, 50, 60 to permit communication between server 70 and devices 20, 30, 40, 50, 60. According to some embodiments, system users such as buyers and sellers may access the server database via a toll free access number. The software application comprises machine readable or interpretable instructions enabling communication between server 70 and devices 20, 30, 40, 50, 60. Network users utilize the devices to transmit signals containing digital data. The digital data identifies the signals with the transmitting device and may also contain digital data corresponding to the user of the transmitting device. In operation, a plurality of servers 70 may be located in different geographic regions, wherein each server 70 is designated to cover a particular region. In a preferred embodiment, all such servers and their corresponding wireless devices share the common software application as described herinabove.

According to an aspect of the present invention, a user (e.g., a buyer) may employ a GPS equipped wireless device 30 to access a multiple listing service via GPS technology to pinpoint the precise location of a given property. Additionally, GPS technology may be used to locate listed real estate open houses and display related information such as the date, time and duration of the open house. According to an additional aspect, visual images such as photographs, streaming video, and aerial photographs may be accessed using a device 20, 30, 40, 50, 60 of the present invention. The system preferably is interactive such that users may follow web-based links to real estate related advertiser websites. Moreover, the system preferably permits a user to store previously viewed images and information for later retrieval.

According to another aspect of the present invention, the server database contains demographic information, including but not limited to: (1) quality of local schools; (2) quality of local neighborhoods; (3) proximity and location of hospitals; (4) proximity and location of shopping; and (5) proximity and location of entertainment. In some embodiments, a click-and-connect feature allows users to immediately and directly connect to a real estate listing agent, broker, or individual by merely clicking an appropriate connecting link, icon, or image located on the wireless device.

In accordance with the principles of the present invention, system 10 allows users (e.g., buyers) to access and retrieve global real estate listings and related information. According to some embodiments, the real estate listings may be accessed and sorted by predetermined search parameters, including but not limited to: (1) location; (2) price; (3) type of property (i.e., commercial, residential, etc.); (4) square footage; and (5) number of bedrooms, home price. According to additional embodiments, the software residing on the devices and server permits a user to make a virtual tour of a selected real estate listing.

According to a further aspect of the present invention, sellers and advertisers may upload real estate information, photos, streaming video and other data in real-time for viewing by potential buyers. This real estate information preferably may be deleted, altered, or updated in real-time using the software residing on the devices and server. Advantageously, real estate sellers and advertisers may track the number, frequency, and demographic makeup of visitors to their listings and advertisements. Additionally, the system preferably further includes a click-and-connect feature that allows users to connect immediately and directly to real estate listing agents, brokers and individuals by clicking on an appropriate connecting link, icon or image. Further, advertisers can include hot links directing potential customers to their own websites.

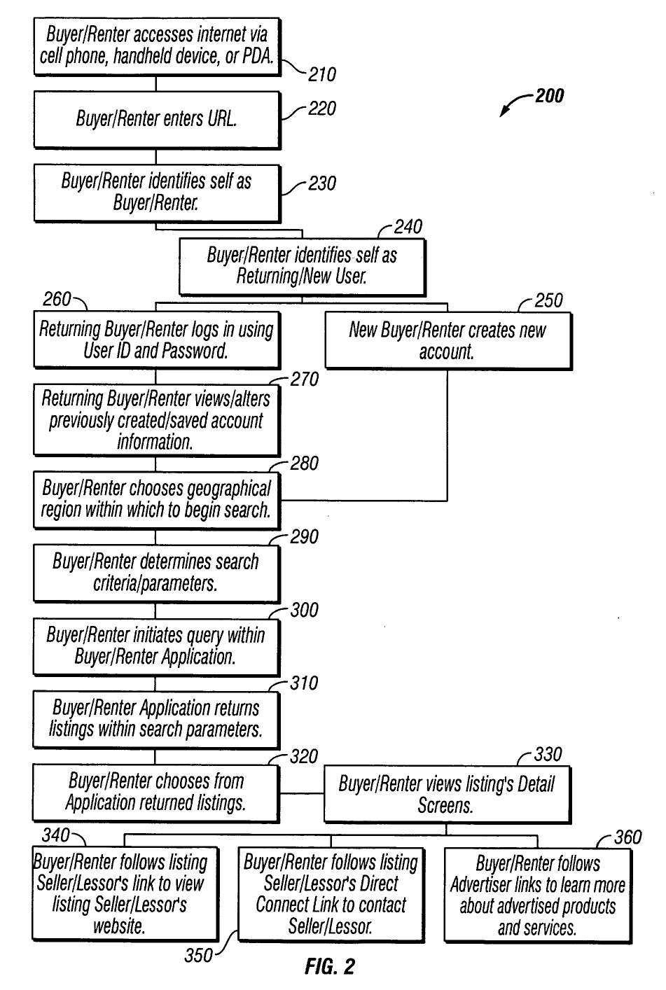

Referring to FIG. 2, a method 200 of identifying and retrieving real estate information in accordance with the principles of the present invention will now be described. In step 210, a user such as a buyer or renter accesses the Internet, for example using any of the devices 20, 30, 40, 50, 60 described above with respect to FIG. 1. Step 220 involves entering the website of the present invention, which may include the steps of typing the appropriate web address (URL) in a web browser address field and pressing enter. In step 230, the user is prompted to identify whether he/she is a buyer or renter, whereas in step 240 the user is prompted to identify whether he/she is a returning user or new user.

If the user is a new user, the method proceeds to step 250, which involves creating a new user account entering a unique user ID and password in appropriate account creation fields within the seller-specific website's homepage. If the user is a returning user, the method proceeds to step 260, which involves logging onto the system by entering the unique user ID and password in appropriate account creation fields within the website's homepage. Optional step 270 involves viewing and/or altering any previously entered account information. Step 280 involves selecting a specific region of the world within which to begin a search. According to some embodiments, this step involves clicking on a graphical representation or icon of the particular world region. According to other embodiments, step 280 involves typing in the appropriate country or region and pressing enter.

With further reference to FIG. 2, step 290 comprises determining the search parameters from a variety of criteria including, but not limited to: (1) location; (2) price; (3) square footage; and (4) number of bedrooms. Other criteria may include whether the buyer prefers to purchase, rent or rent-to-own the property as well as whether the buyer prefers an apartment, condominium or house. The next step (step 300) involves querying the server database within buyer renter application 90 to identify preferred listings that meet the criteria parameters. After the buyer/renter application returns the preferred listings, the next steps involve viewing the preferred real estate listings produced by the aforementioned search (step 310) and selecting a specific real estate listing to view a more detailed screen for the selected listing (step 320). According to some embodiments, step 320 involves clicking on the appropriate real estate listing. According to other embodiments, step 320 involves clicking on a graphical representation or icon of the appropriate listing.

Still referring to FIG. 2, step 330 involves viewing the detailed screen of the selected real estate listing. This step may involve viewing the following detailed real estate information: (1) address; (2) price; (3) listing agent or lessor and related information; (4) GPS coordinates and related map; (5) open house times and dates; (6) photos; (7) aerial images; (8) virtual tour video; (9) area demographics; (10) square footage; (11) number of bedrooms; (12) number of bathrooms; and (13) related links. From within a listings detail screen, a buyer preferably may perform the following additional steps: (1) connecting to a listing agent's or lessor's website by clicking on an appropriate link (step 340); (2) directly contacting a listing agent or lessor by clicking an appropriate link (step 350); and (3) connecting to an advertiser's website or directly contacting an advertiser by clicking on an appropriate link (360).

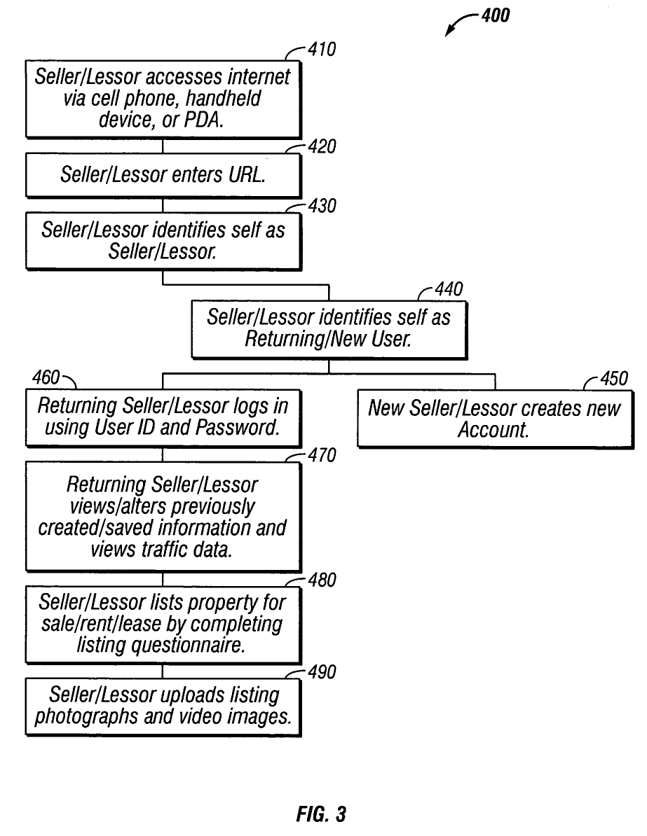

Referring to FIG. 3, a method 400 of establishing and using a seller's database account for identifying and retrieving real estate information in accordance with the principles of the present invention will now be described. An initial step (step 410) involves accessing the Internet, for example using any of the devices 20, 30, 40, 50, 60 described above with respect to FIG. 1. Step 420 involves accessing a seller-specific website by entering the appropriate web address (URL) in the web browser's address field and pressing enter. In step 430, the user is prompted to identify whether he/she is a seller or lessor, whereas in step 440 the user is prompted to identify whether he/she is a returning user or new user.

If the user is a new user, the method proceeds to step 450, which involves creating a seller's proprietary database account by entering a unique user ID and password in appropriate account creation fields within the seller-specific website's homepage. If the user is a returning user, the method proceeds to step 460, which involves logging onto the system by entering the unique user ID and password in appropriate account creation fields within the website's homepage. Optional step 470 involves viewing and/or altering any previously entered account information. Step 480 involves listing a property for sale, rent and/or lease by completing a listing questionnaire. Completing the questionnaire involves entering requested information (e.g., price, square footage, number of bedrooms and bathrooms, location, etc.) in appropriate fields. Step 490 involves uploading photo and video images of the property during the listing process. According to some embodiments, this step involves being prompted by proprietary image transfer software to upload the images. An optional step involves tracking the number, frequency, and demographic makeup of website listing visitors by: entering the unique user ID and password at seller-specific website homepage; choosing a tracking information option; and viewing the available data.

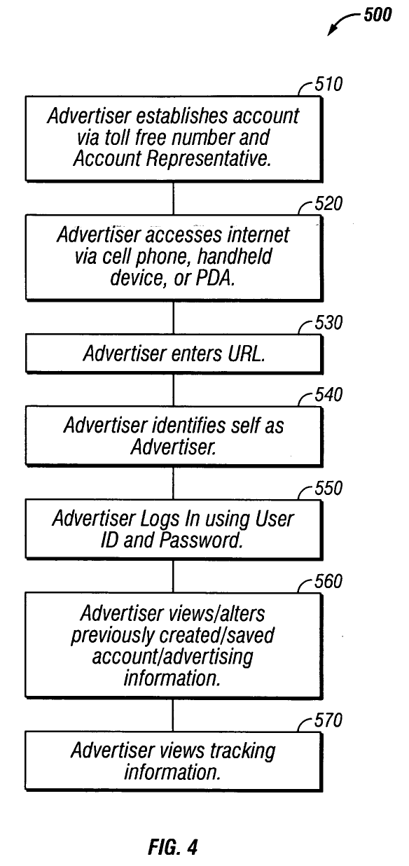

Referring to FIG. 4, a method 500 of establishing and using an advertiser's database account for identifying and retrieving real estate information in accordance with the principles of the present invention will now be described. An initial step (step 510) involves establishing a new account. According to some embodiments, this step involves using a toll free number to speak with an account representative. Step 520 involves accessing the Internet, for example using any of the devices 20, 30, 40, 50, 60 described above with respect to FIG. 1. Step 530 involves accessing an advertiser-specific website by entering the appropriate web address (URL) in the web browser's address field and pressing enter. In step 540, the user is prompted to identify whether he/she is an advertiser. The next step involves accessing the account by entering a unique user ID and password in the user ID and password fields, respectfully. An optional step (step 560) involves altering any previously entered listing information by choosing an edit information option, editing the information and saving the new information. Step 570 involves viewing the website's tracking information by choosing a tracking information option and viewing the available data.

Thus, it is seen that systems and methods for identifying and retrieving real estate information are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A system for allowing access and retrieval of selected real estate information by a plurality of users, the system comprising:
a plurality of devices;
a server in communication with a server database containing real estate information; and
software residing on the server and each device to permit bi-directional communication between the server and the devices.

2. The system of claim 1, wherein the devices comprise wired devices.

3. The system of claim 2, wherein users employing wired devices may access server over the Internet via an ISP.

4. The system of claim 2, wherein the wired devices comprise personal computers.

5. The system of claim 1, wherein the devices comprise wireless devices.

6. The system of claim 5, wherein users employing wireless devices communicate with the server via a wireless communications network that enables communication with the Internet, which is provided in communication with server.

7. The system of claim 1, wherein the devices comprise GPS equipped wireless devices.

8. The system of claim 7, wherein the GPS equipped wireless devices are used to access a multiple listing service via GPS technology to pinpoint the precise location of a given property.

9. The system of claim 7, wherein the GPS technology is used to locate listed real estate open houses and display the date, time and duration of the open house.

10. The system of claim 1, wherein the devices comprise PDAs.

11. The system of claim 1, wherein the devices comprise cellular phones.

12. The system of claim 1, wherein the devices comprise wireless enabled laptops.

13. The system of claim 1, wherein the selected real estate information is chosen from the group consisting of buyer/renter applications, seller/lessor applications and advertiser applications.

14. The system of claim 1, wherein photographs, streaming video, and aerial photographs of the a selected property are accessed using the device.

15. The system of claim 14, wherein the device is used to store previously viewed images and information for later retrieval.

16. The system of claim 1, wherein the server database contains demographic information.

17. The system of claim 16, wherein the demographic information is chosen from the group consisting of quality of local schools, quality of local neighborhoods, proximity and location of hospitals, proximity and location of shopping, and proximity and location of entertainment.

18. The system of claim 1, wherein the device is used to access and retrieve global real estate listings and related information.

19. The system of claim 18, wherein the global real estate listings are accessed and sorted by predetermined search parameters.

20. The system of claim 19, wherein the search parameters are chosen from the group consisting of location, price, type of property, square footage and number of bedrooms.

21. The system of claim 1, wherein a device is used to make a virtual tour of a selected real estate listing.

22. The system of claim 1, wherein a device is used to upload real estate information, photos, streaming video and other data in real-time.

23. A method of identifying and retrieving real estate information by a user, the method comprising the steps of:
using a device to access an appropriate website on the Internet;
selecting a specific region of the world within which to begin a search.
determining the search parameters from a variety of criteria;
querying the server database to identify preferred real estate listings that meet the criteria parameters; and
viewing the preferred real estate listings.

24. The method of claim 23, wherein the step of selecting a specific region of the world within which to begin a search includes the step of clicking on a graphical representation or icon of the particular world region.

25. The method of claim 23, wherein the step of selecting a specific region of the world within which to begin a search includes the step of typing in the appropriate country or region and pressing enter.

26. The method of claim 23, wherein the search parameters are chosen from the group consisting of location, price, square footage and number of bedrooms.

27. The method of claim 23, wherein the search parameters are chosen from the group consisting of whether the buyer prefers to purchase, rent or rent-to-own the property and whether the buyer prefers an apartment, condominium or house.

28. The method of claim 23, further comprising the step of selecting a specific real estate listing to view a more detailed screen for the selected listing.

29. The method of claim 28, further comprising the step of viewing the detailed screen of the selected real estate listing.

30. The method of claim 28, further comprising the step of connecting to a listing agent's or lessor's website by clicking on an appropriate link.

31. The method of claim 28, further comprising the step of directly contacting a listing agent or lessor by clicking an appropriate link.

32. The method of claim 28, further comprising the step of connecting to an advertiser's website or directly contacting an advertiser by clicking on an appropriate link.
